(19) United States
(12) Patent Application Publication
(10) Pub. No.: US 2007/0121317 A1
(43) Pub. Date: May 31, 2007

(54) Solar lighting device having color and brightness control mechanism

(75) Inventors: Bin-Juine Huang, Taipei (TW); Hung-Ta Tsao, Danshuei Township (TW); Mei-Hui Wu, Danshuei Township (TW); Min-Sheng Wu, Taoyuan Hsien (TW); Chun-Kuan Wu, Tai Tung City (TW); Shih-Ming Yan, Kaohsiung Hsien (TW)

Correspondence Address: LEONG C LEI, PMB # 1008, 1867 YGNACIO VALLEY ROAD, WALNUT CREEK, CA, 94598, US

(73) Assignee: GIANT ASIA ENERGY SERVICE CO.

(21) Appl. No.: 11/286,328

(22) Filed: Nov. 25, 2005

(51) Int. Cl. F21L 4/00

(52) U.S. Cl. 362/183

(57) ABSTRACT

A solar lighting device includes a transparent housing. Within the housing, there are provided a light-emitting member (e.g., LED or lamp), a control circuit having a microprocessor and a switch activated by magnetic force, light, or body temperature, and a solar battery for supplying electric power to both the light-emitting member and the control circuit. A transparent or translucent object such as cup, bottle, or ornament may be mounted on the lighting device such that light with varying color and/or brightness may be emitted from the object as controlled by the microprocessor and the switch activated by an approaching trigger member when the lighting device is activated.

### BACKGROUND OF THE INVENTION

(a) Technical Field of the Invention

The present invention relates to solar devices and more particularly to a solar lighting device having means for generating electric power by solar energy and a control circuit for controlling color and brightness of light emitted by a light-emitting member (e.g., LED or lamp) thereof.

(b) Description of the Prior Art

Conventionally, the design of a cup, bottle, flower shaped ornament, or animal or plant shaped ornament made of glass, plastics, or acrylic material emphasizes on the shape thereof. Its aesthetic appearance cannot be appreciated in the night or dark environment. Reflective coating is formed on some cups, bottles, transparent containers, or ornaments for rendering color in certain types. However, its illumination is low and its color is poor. A light may be mounted in such ornaments for aesthetic purpose. However, its external power supply is a big problem. Rechargeable battery or cells may be employed in another design. However, its charging is bothersome if it is rechargeable or its disposal after use may cause environmental pollution if it is non-rechargeable. Thus, continuing improvements in the exploitation of a solar lighting device having a color and brightness control mechanism assembled with container, ornament, or the like are constantly being sought.

### SUMMARY OF THE INVENTION

The primary purpose of the present invention is to provide a solar lighting device adapted to assemble with bottom of a glass, a cup, a flower vase, an alcohol bottle, an ornament, or a transparent or translucent container such that one of the above objects may emit light with varying color and/or brightness when a light-emitting member of the solar lighting device is activated.

It is another object of the present invention to provide a solar lighting device having means for generating electric power by solar energy.

The above and other objects of the present invention are realized by providing a solar lighting device comprising a transparent housing; a control circuit having a light-emitting member for emitting light of different colors; a rechargeable battery electrically connected to the control circuit; and means for converting the radiant energy of sunlight into electric power.

In one aspect of the present invention, the housing is comprised of an upper shell and a lower shell secured together.

In another aspect of the present invention, the conversion means is a plate solar collector.

In yet another aspect of the present invention, the control circuit comprises a microprocessor having an embedded program, the microprocessor being electrically connected to the light-emitting member such that the microprocessor is adapted to change color and brightness of light emitted by the light-emitting member.

In a further aspect of the present invention, the light-emitting member is an LED or a lamp.

In yet further aspect of the present invention, there are further provided an external trigger member and a switch controlled by the microprocessor, and wherein the switch is a magnetic reed switch activated by magnetic force, a light sensitive switch activated by light, or a temperature sensitive switch activated by body temperature such that placing the trigger member proximate the solar lighting device will cause the microprocessor to activate the switch, and a light-emitting mode of the light-emitting member is changed in response to a signal generated by the times of approaching the trigger member to the solar lighting device.

In yet further aspect of the present invention, there is further provided a charging cabinet having an open side and comprises an upper lamp, a light absorbing plate under the lamp, and two parallel crossbars below the light absorbing plate such that for example an upside down glass may hang on the crossbars and the plate solar collector in the glass may absorb the sun's rays and convert the radiant energy of sunlight into electric power which is then supplied to the battery for charging. The provision of charging cabinet as a charging device is particular applicable to an environment when sunlight is weak or even there is no sunlight.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a solar lighting device according to the invention;

FIG. 2 is an exploded view of the solar lighting device showing its internal details according to a first preferred embodiment of the invention;

FIG. 2A is an exploded view of the solar lighting device showing its internal details according to a second preferred embodiment of the invention;

FIG. 3 is a circuit diagram of the solar lighting device;

FIG. 4 is an exploded perspective view of the solar lighting device to be assembled with a glass;

FIG. 4A is a view similar to FIG. 4 showing another configuration of the solar lighting device and the glass shown in FIG. 4;

FIG. 5 is a sectional view of the solar lighting device to be assembled with a glass;

FIG. 5A is a view similar to FIG. 5 where the solar lighting device is exploded to show another configuration thereof;

FIG. 6 is a perspective view of the solar lighting device assembled with another glass;

FIG. 6A is an exploded perspective view of the solar lighting device shown in FIG. 6;

FIG. 7 is a perspective view of the solar lighting device assembled with yet another glass;

FIG. 7A is an exploded perspective view of the solar lighting device shown in FIG. 7;

FIG. 8 is a perspective view of charging cabinet for charging the consumed solar lighting device assembled with glass;

FIG. 8A is a perspective view of mask for charging the consumed solar lighting device assembled with glass;

FIG. 9 is a perspective view of the solar lighting device assembled with a glass showing light emitted by the solar lighting device by placing a trigger member proximate thereto;

FIG. 10 is a view similar to FIG. 8 showing light emitted from another glass by the solar lighting device by placing a trigger member proximate thereto where the trigger member has a different shape;

FIG. 11 is a perspective view of the solar lighting device assembled with a menu board;

FIG. 11A is an exploded perspective view showing another configuration of the solar lighting device and the menu board shown in FIG. 11;

FIG. 12 is a perspective view of the solar lighting device assembled with a flower vase;

FIG. 12A is an exploded perspective view showing another configuration of the solar lighting device and the flower vase shown in FIG. 12;

FIG. 13 is an exploded perspective view the solar lighting device assembled with a pad together to be assembled with a glass;

FIG. 14 is a perspective view of the solar lighting device assembled with an alcohol bottle;

FIG. 14A is an exploded perspective view showing another configuration of the solar lighting device and the alcohol bottle shown in FIG. 14;

FIG. 15 is a perspective view of the solar lighting device assembled with a crystal ball;

FIG. 15A is an exploded perspective view showing another configuration of the solar lighting device and the crystal ball shown in FIG. 15;

FIG. 16 is a perspective view of the solar lighting device assembled with a lamp; and

FIG. 16A is an exploded perspective view showing another configuration of the solar lighting device and the lamp shown in FIG. 16.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

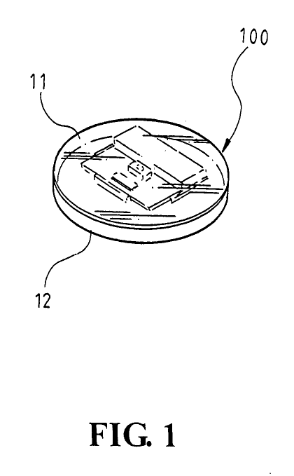

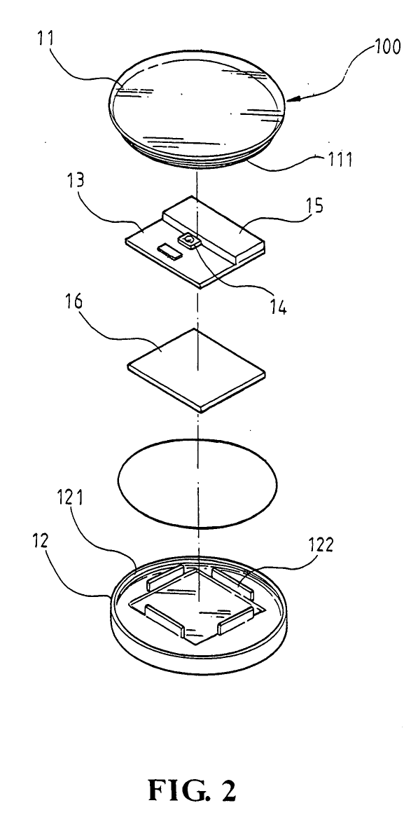

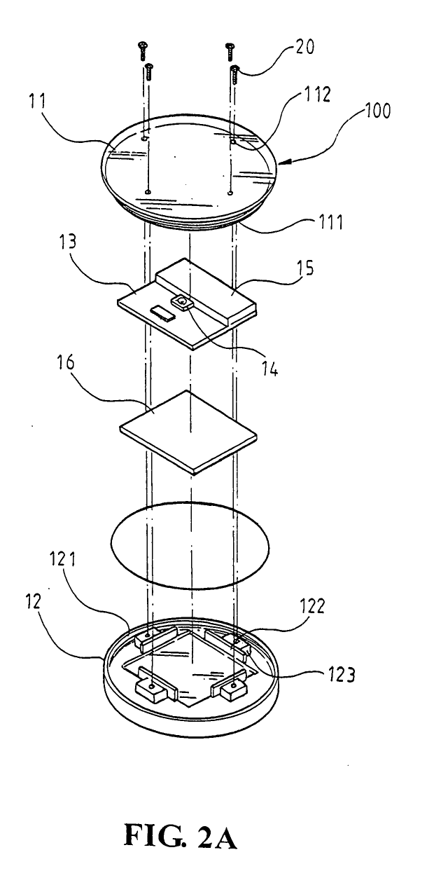

Referring to FIGS. 1, 2, and 3, a disk-shaped solar lighting device 100 in accordance with the invention is shown. The device 100 comprises an upper shell 11 and a lower shell 12 both formed of transparent or translucent material. As shown in FIG. 2, outer threads 111 are formed around a lower portion of the upper shell 11 and inner threads 122 are formed around an inner surface of the lower shell 12. The outer and inner threads 111 and 122 are adapted to engage for securing the upper and lower shells 11 and 12 together. In another configuration as shown in FIG. 2A, four through holes 112 are formed in the upper shell 11. Four walls 122 are arranged at four sides of a rectangular area on the lower shell 12. Four blocks 123 with a threaded hole are formed with the walls 122. Four screws 20 are adapted to drive through the holes 112 into the blocks 123 for securing the upper and lower shells 11 and 12 together.

Within a housing consisting of the upper and lower shells 11 and 12, there are provided a control circuit 13 in the shape of a board, the control circuit 13 having a top light-emitting member (e.g., LED (light-emitting diode) or lamp) 14 for emitting different colors, and a rechargeable battery 15 formed on the control circuit 13 and electrically connected thereto, and a square plate solar collector 16 formed on a bottom of the control circuit 13 for charging the battery 15 by converting the radiant energy of sunlight into electric power. Both the control circuit 13 and the plate solar collector 16 are fastened by the walls 122 on the lower shell 12.

The control circuit 13 comprises a microprocessor 131 electrically connected to the battery 15, the plate solar collector 16, and the light-emitting member 14, the microprocessor 131 including an embedded program, and a switch 132 controlled by the microprocessor 131, the switch 132 being adapted to activate by magnetic force, light, or body temperature for 15 controlling color and brightness of light emitted by the light-emitting member 14 as detailed later.

The control circuit 13 further comprises a voltage stabilizer (e.g., Zener diode) 133 for stabilizing electric power from the battery 15 such that the control circuit 13 may operate normally under a predetermined operating voltage. The light-emitting member 14 is implemented as a red-green-blue LED and is activated by red, green, and blue transistors 134 which are electrically connected to the microprocessor 131 such that light with varying color and/or brightness may be emitted from the light-emitting member 14.

The solar lighting device 100 is adapted to assemble with bottom or therewithin of a glass, a cup, a flower vase, an alcohol bottle, an ornament, or a transparent or translucent container. Thus, one of the above objects may emit light with varying color and/or brightness when the light-emitting member 14 is activated.

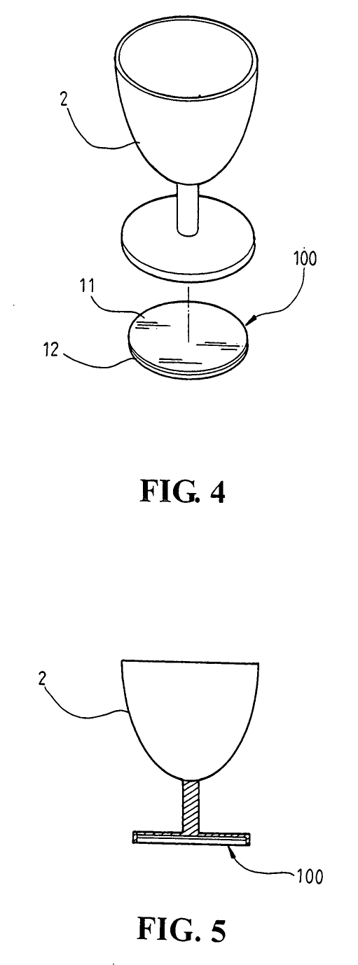

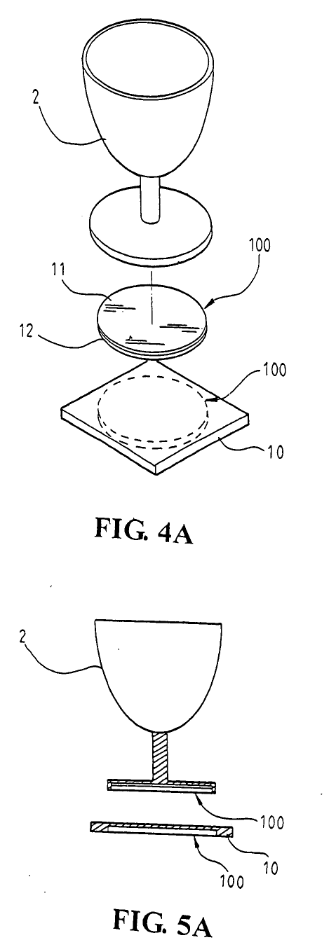

Referring to FIGS. 4, 4A, 5, and 5A, the solar lighting device 100 is mounted under a glass 2 (see FIGS. 4 and 5) or on a pad 10 with the glass 2 placed thereon (see FIGS. 4A and 5A). Thus, the glass 2 may emit light with varying color and/or brightness when the solar lighting device 100 is activated.

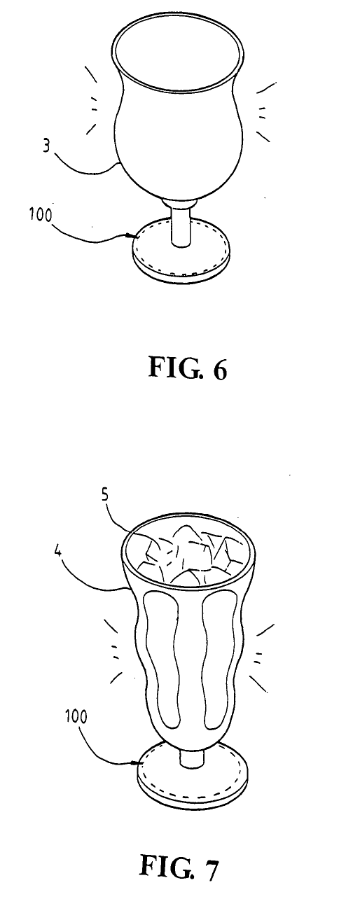

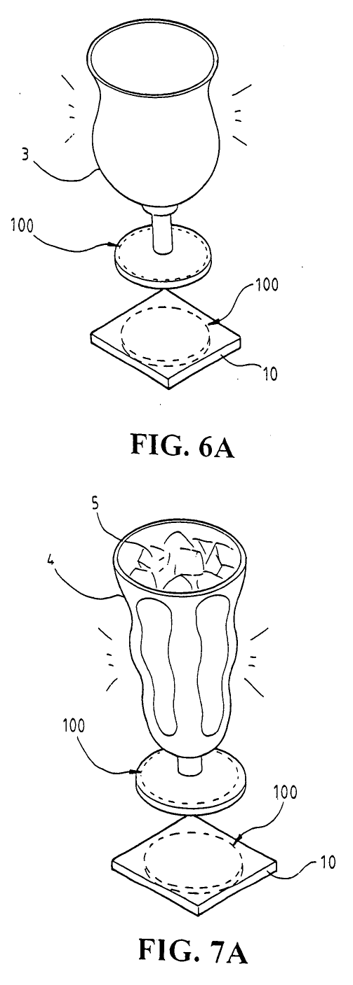

Referring to FIGS. 6, 6A, 7, and 7A, the solar lighting device 100 is adapted to assemble with one of a plurality of glasses 3 and 4 having different shapes. As shown in FIGS. 7 and 7A, ice 5 is filled in the glass 4 such that an additional dazzling effect of reflecting light by the ice 5 is carried out.

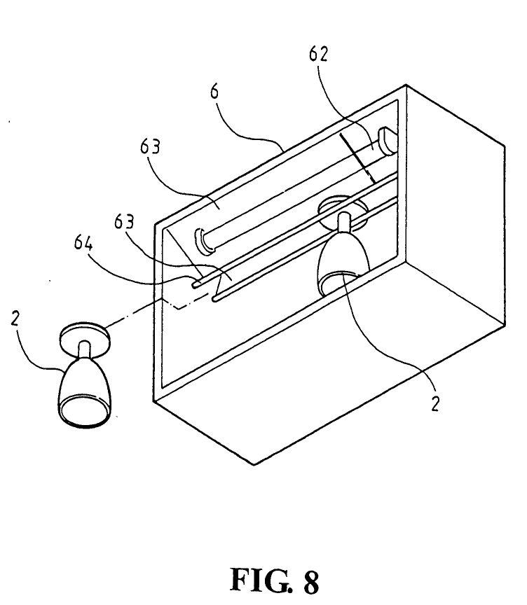

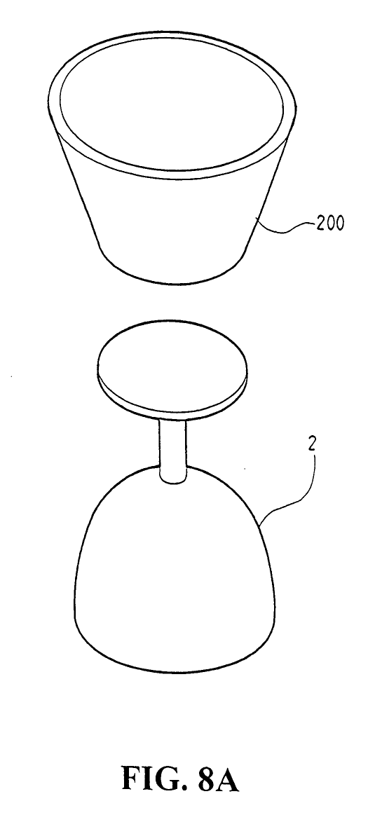

Referring to FIG. 8, for charging the solar lighting device 100 formed with a glass 2 a user may place the glass 2 upside down to concentrate the sun's rays on the plate solar collector 16 and the battery 15 is thus charged. An additional effect of killing microorganism contained in the glass 2 is also carried out. The glass 2 may place in a charging cabinet 6 for charging when sunlight is weak or even there is no sunlight. The charging cabinet 6 is a box having an open side. Within the charging cabinet 6, there are provided an upper lamp 62, a light. absorbing plate 63 under the lamp 62, and two parallel crossbars 64 below the light absorbing plate 63 such that an upside down glass 2 may hang on the crossbars 64. In this position, the plate solar collector 16 in the glass 2 may absorb the sun's rays and convert the radiant energy of sunlight into electric power which is then supplied to the battery 15 for charging. Referring to FIG. 8A, in another configuration such as in a sunny day a conic mask 200 is placed above the glass 2 to concentrate the sun's rays for increasing the generation of electric power.

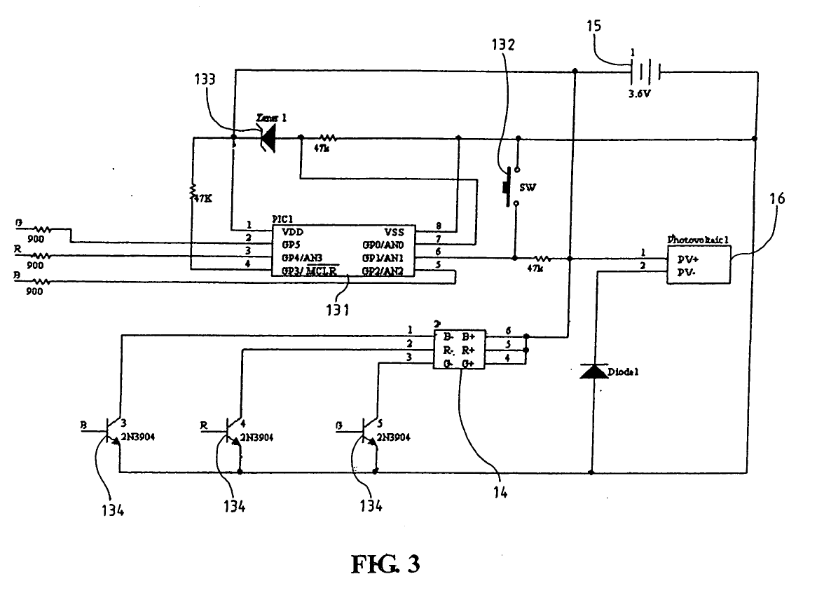

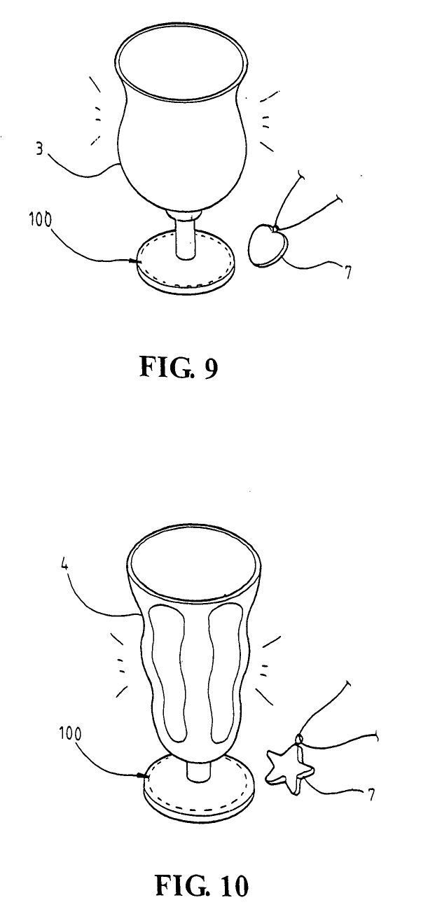

Referring to FIGS. 9 and 10 in conjunction with FIG. 3, the switch 132 is implemented as a magnetic reed switch, a light sensitive switch, or a temperature sensitive switch. Thus, a user may place a trigger member 7 proximate bottom of a glass 3 or 4 for activating the switch 132 and thus changing a light-emitting mode of the light-emitting member 14 in which the magnetic reed switch is activated by magnetic force, the light sensitive switch is activated by light, and the temperature sensitive switch is activated by body temperature. Moreover, the microprocessor 131 may change a light-emitting mode of the light-emitting member 14 in response to a signal generated by the times of approaching the trigger member 7 to the glass 3 or 4. Further, the trigger member 7 may be shaped as a heart (see FIG. 9), a star (see FIG. 10), or the like.

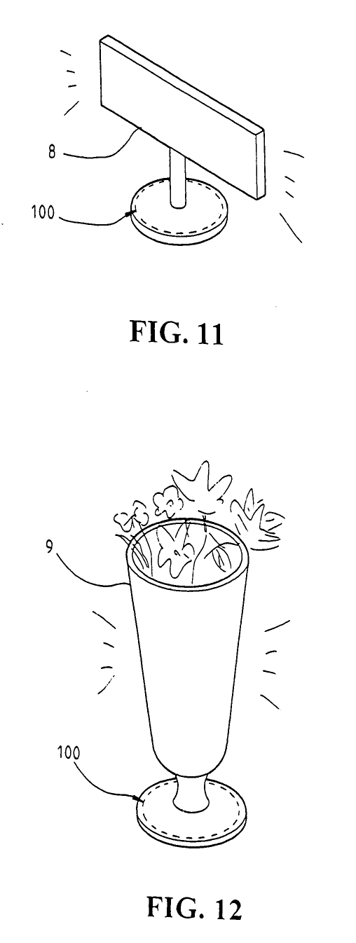

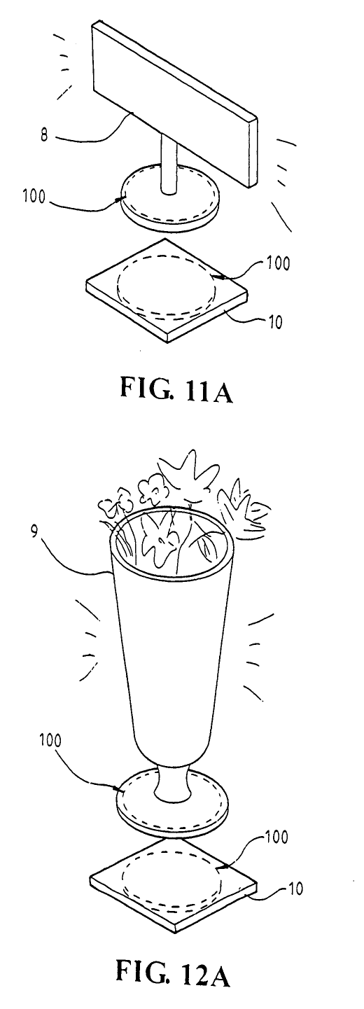

Referring to FIGS. 11 and 11A, the solar lighting device 100 is mounted on a bottom of a leg of a menu board 8 (see FIG. 11). Further, the assembled solar lighting device 100 and the menu board 8 may place on a pad 10 (see FIG. 11 A). The menu board 8 is lit by the solar lighting device 100 for illuminating menu placed or printed on the menu board 8. Referring to FIGS. 12 and 12A, the solar lighting device 100 is mounted on a bottom of flower vase 9 (see FIG. 12). Further, the assembled solar lighting device 100 and the flower vase 9 may place on a pad 10 (see FIG. 12A). The flower vase 9 is lit by the solar lighting device 100 such that the flower vase 9 can be more attractive.

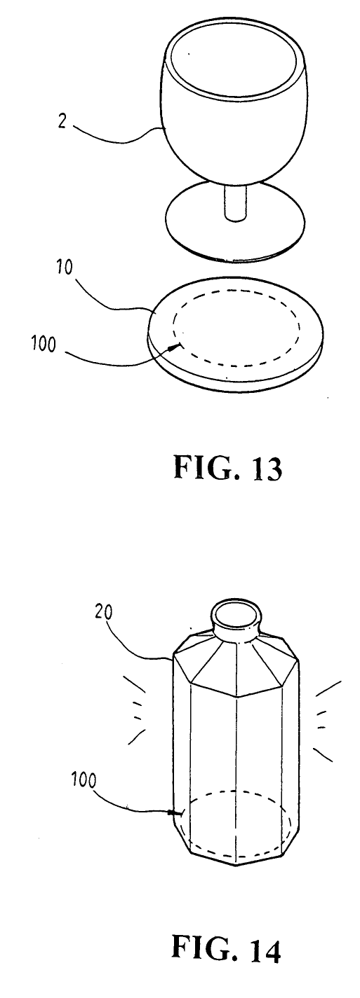

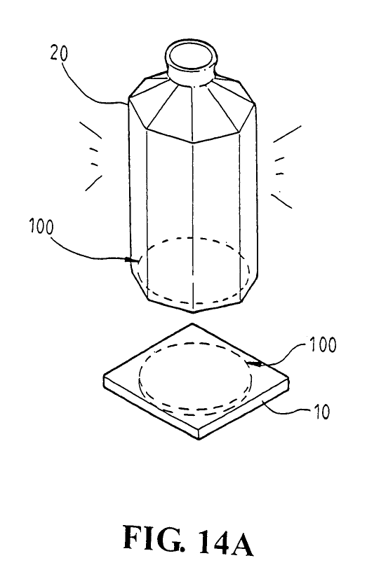

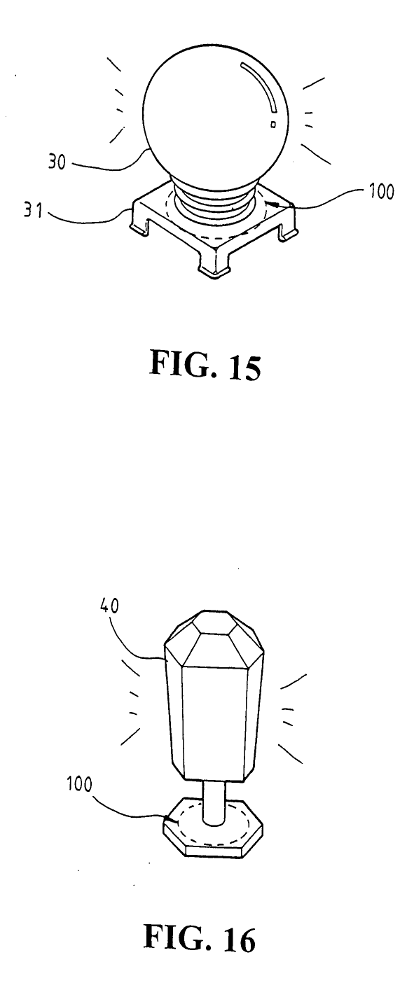

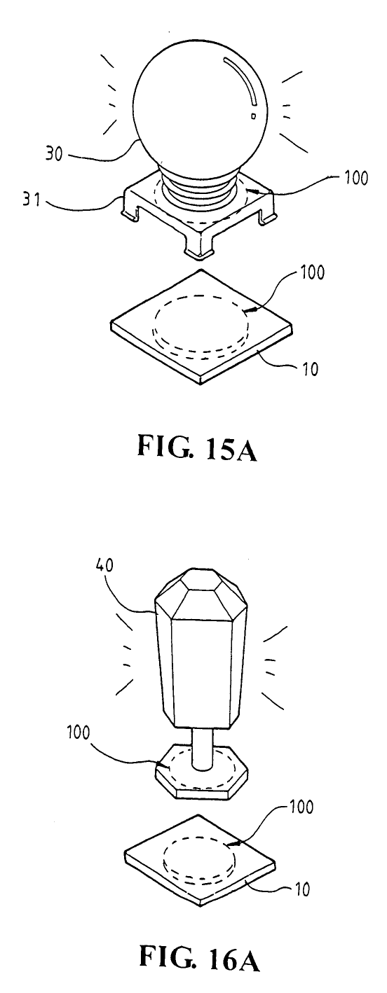

Referring to FIG. 13, the solar lighting device 100 is formed as a pad 10 such that a glass 2 placed thereon may be lit by the solar lighting device 100. Referring to FIGS. 14 and 14A, the solar lighting device 100 is mounted on a bottom of an alcohol bottle 20 (see FIG. 14). Further, the assembled solar lighting device 100 and the alcohol bottle 20 may place on a pad 10 (see FIG. 14A). The alcohol bottle 20 is lit by the solar lighting device 100 for showing a varying color and brightness. Referring to FIGS. 15 and 15A, the solar lighting device 100 is mounted on a stand 31 of a crystal ball 30 (see FIG. 15). Further, the assembled solar lighting device 100 and the crystal ball 30 may place on a pad 10 (see FIG. 15A). Referring to FIGS. 16 and 16A, the solar lighting device 100 is mounted on a bottom of a leg of a lamp 40 (see FIG. 16). Further, the assembled solar lighting device 100 and the lamp 40 may place on a pad 10 (see FIG. 16A).

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A solar lighting device comprising:
a transparent housing;
a control circuit having a light-emitting member for emitting light of different colors;
a rechargeable battery electrically connected to the control circuit; and
means for converting the radiant energy of sunlight into electric power.

2. The solar lighting device of claim 1, wherein the housing is comprised of an upper shell and a lower shell secured together.

3. The solar lighting device of claim 1, wherein the conversion means is a plate solar collector.

4. The solar lighting device of claim 1, wherein the control circuit comprises a microprocessor having an embedded program, the microprocessor being electrically connected to the light-emitting member such that the microprocessor is adapted to change color and brightness of light emitted by the light-emitting member.

5. The solar lighting device of claim 1, wherein the light-emitting member is an LED or a lamp.

6. The solar lighting device of claim 1, further comprising an external trigger member and a switch controlled by the microprocessor, and wherein the switch is a magnetic reed switch activated by magnetic force, a light sensitive switch activated by light, or a temperature sensitive switch activated by body temperature such that placing the trigger member proximate the solar lighting device will cause the microprocessor to activate the switch, and a light-emitting mode of the light-emitting member is changed in response to a signal generated by the times of approaching the trigger member to the solar lighting device.
